(19) United States
(12) Patent Application Publication
(10) Pub. No.: US 2011/0291024 A1
(43) Pub. Date: Dec. 1, 2011

(54) ULTRAVIOLET LIGHT SOURCE

(76) Inventors: Shuo-Ting YAN, Hsin-Chu (TW); Sy-Haw Wang, Hsin-Chu (TW)

(21) Appl. No.: 12/859,638

(22) Filed: Aug. 19, 2010

(30) Foreign Application Priority Data
May 25, 2010 (TW) 099209820

(51) Int. Cl. G21K 5/08; G21K 5/02

(52) U.S. Cl. 250/454.11; 250/504 R

(57) ABSTRACT

An ultraviolet light source includes a casing holding therein UV lamp tubes and a translucent panel above the UV lamp tubes, a filter panel, a side frame surrounding the filter panel, and a hinge connected between the casing and side frame for enabling the filter panel to be turned with the side frame about the axis of the hinge relative to the casing. Moreover, the hinge and the side frame are made of metal material or metal alloy for avoiding breakage of the part of the filter panel connected with the hinge under long radiation of the emitted ultraviolet light. When in use, a bio-sample is placed on the translucent panel, and then the filter panel is closed on the casing over the bio-sample, so that the user can observe the bio-sample or pickup the image of the bio-sample without exposing the body to the emitted ultraviolet light.

### FIELD OF THE INVENTION

The present invention relates to an ultraviolet light source for bio-sample study, wherein a filter panel connects with a casing via a hinge and a side frame for enhancing the convenience of use and prolonging the working life.

### BACKGROUND

When making a biomolecular analysis, biomolecules may be mixed in a gel, and then an electric field may be applied to the gel matrix for separation of molecules. This procedure is called gel electrophoresis.

After gel electrophoresis, a bio-sample can be placed on an UV light box for further observation or image pickup. FIG. 1 illustrates a conventional UV light box. According to this design, the UV light box 10 comprises a box body 11, a translucent panel 13 and an ultraviolet filter panel 15. The box body 11 accommodates therein at least one, for example, a number of UV lamp tubes 12. The translucent panel 13 is located on the top side of the box body 11, and the ultraviolet light emitted by the UV lamp tubes 12 can pass through the translucent panel 13 to the outside.

When using the UV light box 10, a bio-sample 14 is placed on the translucent panel 13, enabling the emitted ultraviolet light to project on the bio-sample 14. The ultraviolet filter panel 15 is placed on the bio-sample 14 and the translucent panel 13. When the emitted ultraviolet light projects on the bio-sample 14, a part of the ultraviolet light penetrates through the bio-sample 14, and the other part of the ultraviolet light excites the bio-sample 14 to produce a different wavelength of first light L1 that has a wavelength longer than the ultraviolet light emitted by the UV lamp tubes 12.

The ultraviolet filter panel 15 is adapted for filtering the ultraviolet light that penetrates through the bio-sample 14 and the translucent panel 13. The first light L1 can penetrate through the ultraviolet filter panel 15, enabling the user to observe the light pattern of the first light L1 through the ultraviolet filter panel 15, or to pick up the image of the light pattern of the first light L1 with an image sensor. Further, the use of the ultraviolet filter panel 15 prevents falling of the ultraviolet light emitted by the UV lamp tubes 12 upon the user's body, avoiding injury due to long exposure to ultraviolet light.

The use of the aforesaid UV light box 10 allows observation of a bio-sample 14 or image pickup. However, this design of UV light box 10 is still not satisfactory in function. For example, after positioning of a bio-sample 14 on the translucent panel 13, the user must place the ultraviolet filter panel 15 on the bio-sample 14 at the translucent panel 13 to filter the ultraviolet light that penetrates through the bio-sample 14 and the translucent panel 13. When placing the ultraviolet filter panel 15 on the bio-sample 14 at the translucent panel 13, the bio-sample 14 may be damaged accidentally due to improper postures. Further, it is inconvenient to pick up the ultraviolet filter panel 15 for replacement of a bio-sample 14 during the use of the UV light box 10.

### SUMMARY OF THE PRESENT INVENTION

It is an object of the present invention to provide an ultraviolet light source, which uses a hinge and a side frame to connect a filter panel and a casing, enabling the filter panel and/or side frame to be biased relative to the casing between a close position and an open position, and facilitating placing or removable of a bio-sample.

It is another object of the present invention to provide an ultraviolet light source, which uses a metal hinge to connect the filter panel to the casing. Moreover, a side frame surrounds the filter panel to avoid breakage of the part of filter panel connected with the hinge under long radiation of the emitted ultraviolet light.

It is another object of the present invention to provide an ultraviolet light source, which uses a metal hinge to connect the filter panel to the casing, avoiding change of the structural characteristics of the hinge under long radiation of the emitted ultraviolet light.

It is still another object of the present invention to provide an ultraviolet light source, which uses a side frame to surround the filter panel and a hinge to connect the side frame to the casing, enabling the filter panel (side frame) to be opened and closed conveniently. The hinge and side frame both are made of metal material, avoiding change of the structural characteristics of the hinge and/or the side frame under long radiation of the emitted ultraviolet light.

It is still another object of the present invention to provide an ultraviolet light source, which provides a protruding member at the side frame that surrounds the filter panel, facilitating opening/closing between the filter panel (side frame) and the casing by the user.

It is still another object of the present invention to provide an ultraviolet light source, which has a positioning device connected between the side frame (filter panel) and the casing, facilitating opening of the side frame (filter panel) from the casing and positioning of the side frame (filter panel) in a predetermined angular position relative to the casing where a predetermined included angle is defined between the side frame (filter panel) and the casing, and avoiding sudden falling of the side frame and the filter panel from the open position to the close position during replacement of a bio-sample.

In an aspect of the present invention, an ultraviolet light source comprises: a casing accommodating therein at least one UV light-emitting device for emitting an ultraviolet light; a translucent panel mounted in the casing for allowing the ultraviolet light emitted by the UV light-emitting device to penetrate therethrough; a filter panel adapted for filtering the ultraviolet light emitted by the UV light-emitting device; a side frame surrounding the filter panel; and at least one hinge made of a metal material or a metal alloy and connected between the side frame and the casing for enabling the side frame and the filter panel to be turned about the axis of the hinge relative to the casing.

In another aspect of the present invention, an ultraviolet light source comprises: a casing accommodating therein at least one UV light-emitting device for emitting an ultraviolet light; a translucent panel mounted in the casing for allowing the ultraviolet light emitted by the UV light-emitting device to penetrate therethrough; a filter panel adapted for filtering the ultraviolet light emitted by the UV light-emitting device; and at least one hinge made of a metal material or a metal alloy and connected between the filter panel and the casing for enabling the filter panel to be turned about the axis of the hinge relative to the casing.

### BRIEF DESCRIPTION OF THE DRAWINGS

FIG. 1 is a perspective view of an UV light box according to the prior art.

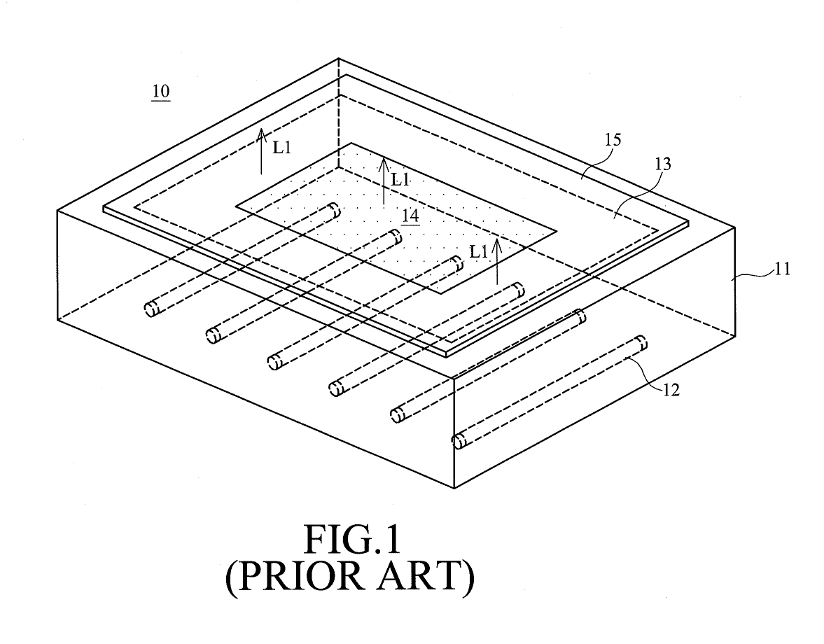

FIG. 2 is an exploded view of an ultraviolet light source in accordance with a first embodiment of the present invention.

FIG. 3 is a schematic drawing of the ultraviolet light source in accordance with the first embodiment of the present invention, showing the side frame and the translucent panel of opened from the casing.

FIG. 4 is a schematic drawing of the ultraviolet light source in accordance with the first embodiment of the present invention, showing the side frame and the translucent panel of closed on the casing.

FIG. 5 is a perspective view of an ultraviolet light source in accordance with a second embodiment of the present invention.

FIG. 6 is a schematic side view of an ultraviolet light source in accordance with a third embodiment of the present invention.

### DETAILED DESCRIPTION OF THE PREFERRED EMBODIMENTS

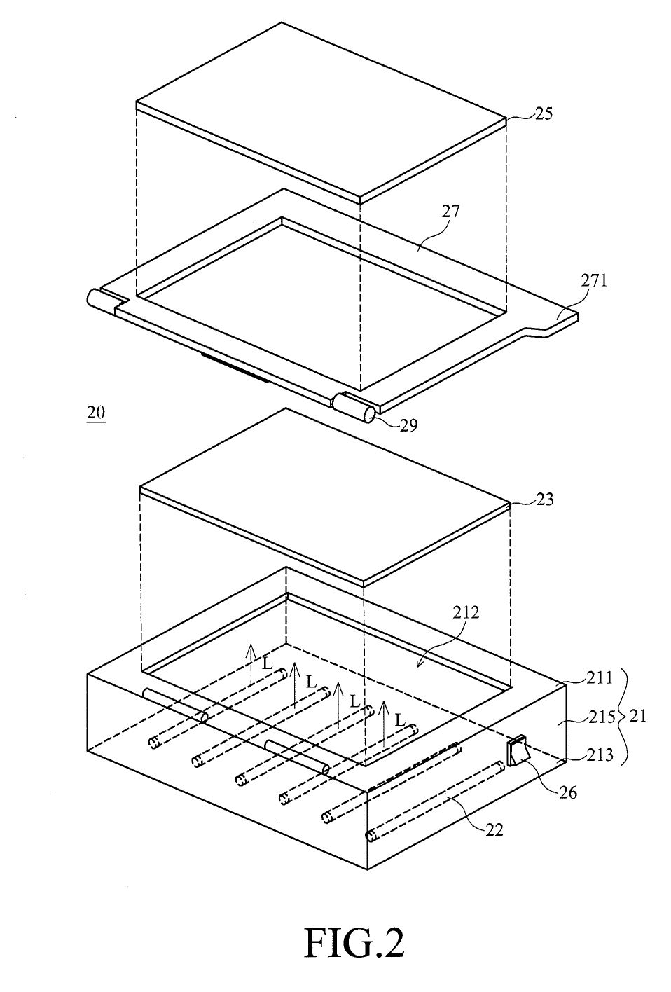

Referring to FIG. 2, an ultraviolet light source in accordance with a first embodiment of the present invention is shown. The ultraviolet light source 20 comprise a casing 21, a translucent panel 23, a filter panel 25, a side frame 27 and a hinge 29. The filter panel 25 and the side frame 27 are turnable relative to the casing 21 between a close position and an open position.

The casing 21 is adapted for accommodating at least one, for example, a number of UV light-emitting devices 22 that are adapted for emitting ultraviolet light L. The UV light-emitting devices 22 can be ultraviolet lamp tubes or ultraviolet LEDs (light-emitting diodes).

The translucent panel 23 is arranged on the top side of the casing 21. The translucent panel 23 is made of an ultraviolet transmissive material so that the ultraviolet light L emitted by the UV light-emitting devices 22 in the casing 21 can pass through the translucent panel 23 to the outside. The casing 21 has a top panel 211, a bottom panel 213 opposite to the top panel 211, and a plurality of peripheral panels 215 arranged between the top panel 211 and the bottom panel 213 around the border.

Further, the casing 21 has an opening 212 cut through the top and bottom sides of the top panel 211. The translucent panel 23 is mounted in the opening 212 in the top panel 211. The UV light-emitting devices 22 are arranged on the top side of the bottom panel 213 inside the casing 21 for emitting ultraviolet light L through the translucent panel 23 toward the outside.

The filter panel 25 is adapted for filtering the ultraviolet light L emitted by the UV light-emitting devices 22. The filter panel 25 can be made of a glass material, for example, UV black glass. Alternatively, the filter panel 25 can be prepared from polymers, for example, polymethylmethacrylate (PMMA).

The side frame 27 surrounds the periphery of the filter panel 25 to hold the filter panel 25 in place. The hinge 29 is located on one side of the side frame 27 to connect the side frame 27 and the casing 21 together, allowing biasing of the side frame 27 with the filter panel 25 relative to the casing 21. Further, the hinge 29 can be made having the function of holding the side frame 27 and the filter panel 25 in a particular position, for example, the side frame 27 and the filter panel 25 can be held by the hinge 29 in a particular angle relative to the top panel 211.

During the use of the ultraviolet light source 20, the ultraviolet light L emitted by the UV light-emitting devices 22 will partially project on the filter panel 25, the hinge 29 and/or the side frame 27. Preferably, the hinge 29 and/or the side frame 27 can be made of a metal material or a metal alloy to avoid change of the structural characteristics of the hinge 29 and/or side frame 27 under long radiation of the ultraviolet light L. If a plastic material is used for making the hinge 29, exposure of the hinge 29 to the ultraviolet light L for a long period will cause the hinge 29 to deteriorate and to break. Using a metal material or a metal alloy for making the hinge 29 and/or the side frame 27 can eliminate the problem of deterioration and breaking.

Furthermore, the side frame 25 surrounds the filter panel 25, and the hinge 29 connects between the side frame 25 and the casing 21. In other words, the hinge 29 does not connect with the filter panel 25 directly to avoid breakage of the part of filter panel 25 connected with the hinge 29 under long radiation of the emitted ultraviolet light.

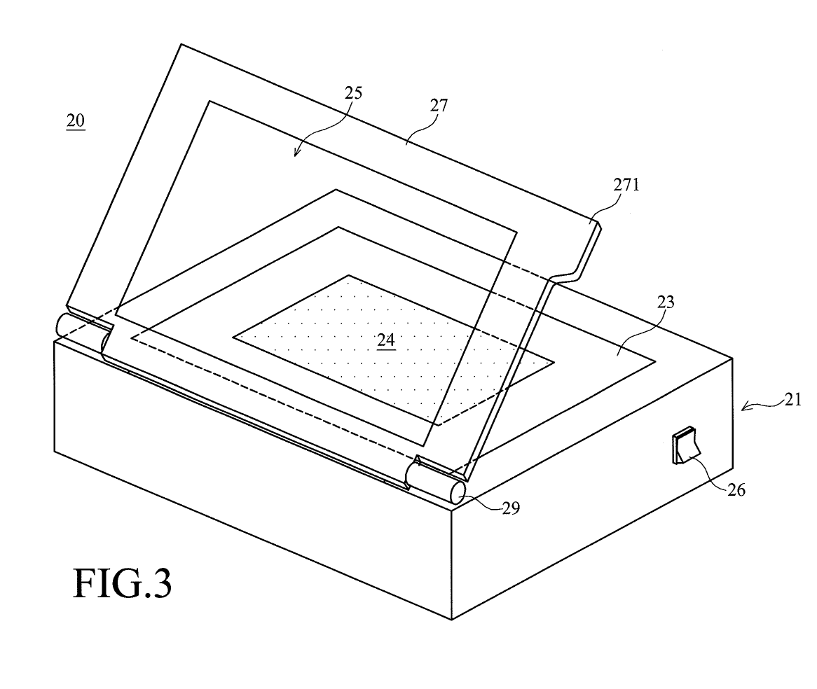

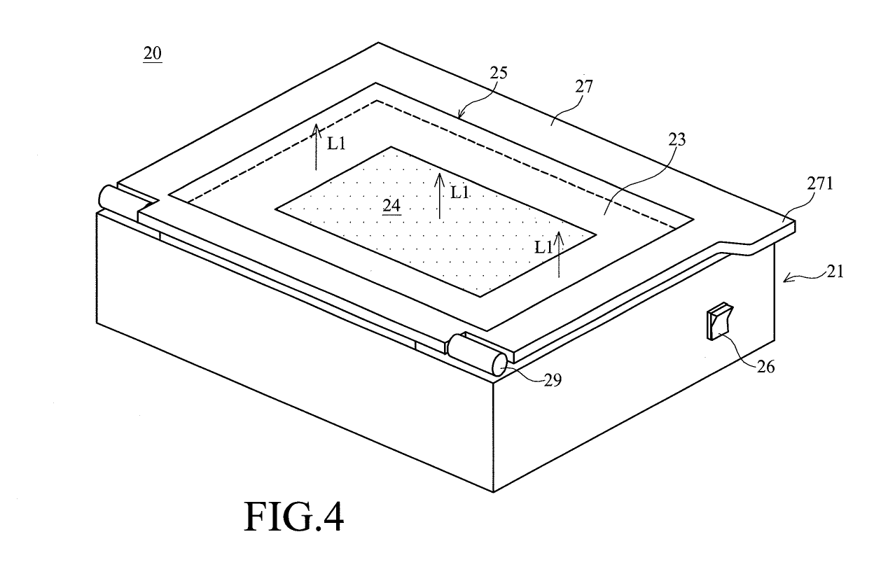

When a user uses the ultraviolet light source 20, the user can open the side frame 27 and the filter panel 25 from the casing 21, and then put a bio-sample 24 on the top side of the translucent panel 23, enabling the bio-sample 24 to be supported on the translucent panel 23, as shown in FIG. 3. After the bio-sample 24 has been properly positioned on the top side of the translucent panel 23, the user can close the side frame 27 and the filter panel 25 to keep the filter panel 25 at the top side relative to the bio-sample 24 and the translucent panel 23, and then turn on the UV light-emitting devices 22 to emit ultraviolet light L, as shown in FIG. 4.

According to this embodiment, the ultraviolet light source 20 further comprises a switch 26 that is operable to switch on/off the UV light-emitting devices 22. The switch 26 can be mounted on, for example, one peripheral panel 215 of the casing 21. When using the ultraviolet light source 20, the user can close the filter panel 25 and then switch on the switch 26 to drive the UV light-emitting devices 22 to emit ultraviolet light L, avoiding accidental radiation of the emitted ultraviolet light L onto the user's body.

When the ultraviolet light L projects on the bio-sample 24, a part of the ultraviolet light L goes through the bio-sample 24, and the other part of the ultraviolet light L excites the bio-sample 24 to produce a different wavelength of first light L1. Normally, the wavelength of the first light L1 is longer than the ultraviolet light L.

The filter panel 25 is adapted to filter the ultraviolet light L that goes through the bio-sample 24 and the translucent panel 23. The first light L1 can penetrate through the filter panel 25 so that the user can view the pattern of the first light L1 through the filter panel 25, or catch the image of the pattern of the first light L1 with an image sensor (not shown).

In order to enhance the convenience of using the ultraviolet light source 20, the side frame 27 is made having a protruding member 271. Through the protruding member 271, a user can close or open the side frame 27 and the filter panel 25 conveniently. The protruding member 271 can be located on one lateral side of the side frame 27, protruding over the adjacent peripheral panel 215. Alternatively, the protruding member 271 can be located on the top side of the side frame 27, and made in the shape of a handle convenient for grasping with the hand.

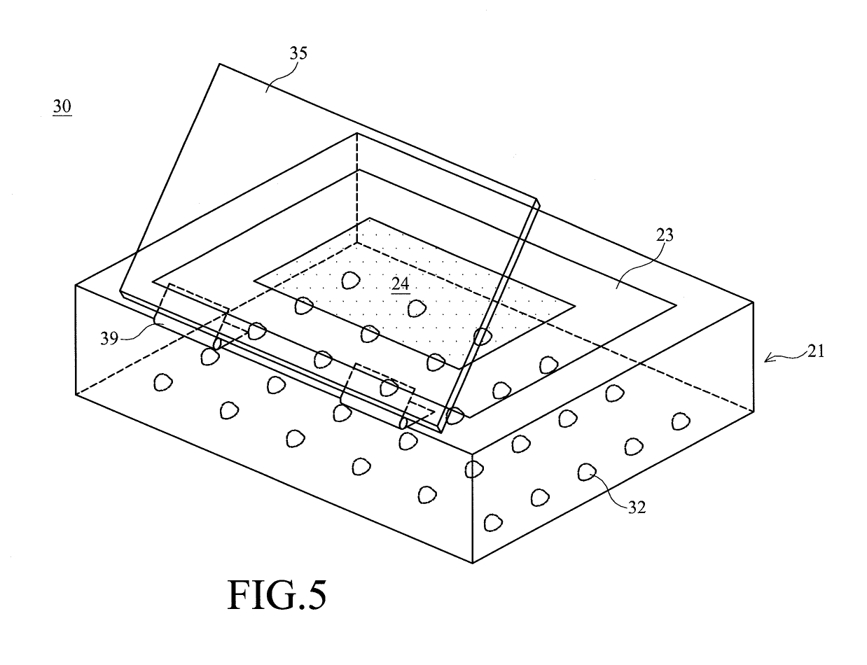

FIG. 5 illustrates an alternate form of the ultraviolet light source in accordance with a second embodiment of the present invention. According to this second embodiment, the ultraviolet light source 30 comprises a casing 21, a translucent panel 23, a filter panel 35 and at least one, for example, two hinges 39. The filter panel 35 is connected to the casing 21 by the hinges 39 so that the user can turn the filter panel 35 about the axis of the hinges 39 relative to the casing 21 between an open position and a close position.

The casing 21 accommodates at least one, for example, a number of UV light-emitting devices 32. The UV light-emitting devices 32 can be ultraviolet lamp tubes or ultraviolet LEDs (light-emitting diodes). The translucent panel 23 is arranged on the top side of the casing 21. The ultraviolet light L emitted by the UV light-emitting devices 22 in the casing 21 can pass through the translucent panel 23 to the outside.

The filter panel 35 is adapted for filtering the ultraviolet light emitted by the UV light-emitting devices 32. According to this embodiment, no side frame (27) is used to surround the filter panel 35, and the filter panel 35 is directly connected to the casing 21 by the hinges 39. The hinges 39 are made of a metal material or a metal alloy. When using the ultraviolet light source 30, the filter panel 35 can be turned about the axis of the hinges 39 relative to the casing 21. After opened the filter panel 35, the user can put a bio-sample 24 on the top side of the translucent panel 23. After the bio-sample 24 has been properly positioned on the top side of the translucent panel 23, the user can close the filter panel 35, enabling the filter panel 35 to filter the ultraviolet light that penetrating through the translucent panel 23 and the bio-sample 25, avoiding long exposure of the user's body to the ultraviolet light. Moreover, the user can observe the bio-sample 24, or pick up the image of the bio-sample 24 via the filter panel 35.

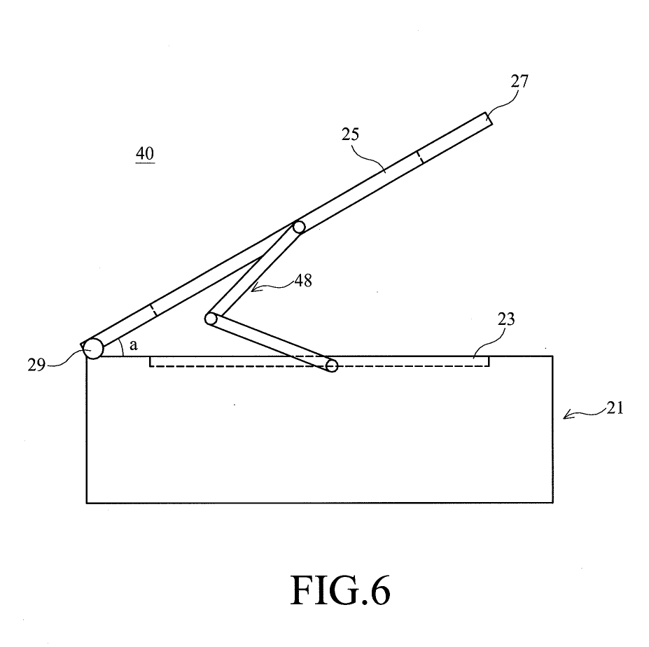

FIG. 6 illustrates an alternate form of the ultraviolet light source in accordance with a third embodiment of the present invention. According to this third embodiment, the ultraviolet light source 40 comprises a casing 21, a translucent panel 23, a filter panel 25, a side frame 27 and at least one hinge 29. The side frame 27 surrounds the filter panel 25, and the side frame 27 is connected to the casing 21 by the at least one hinge 29 so that the user can turn the filter panel 25 about the axis of the at least one hinge 29 relative to the casing 21 between an open position and a close position. The side frame 27 and the at least one hinge 29 are made of a metal material or a metal alloy.

At least one positioning device 48 is connected between the side frame 27 and the casing 21 to facilitate opening of the filter panel 25 from the casing 21 and positioning of the filter panel 25 in a predetermined angular position relative to the casing 21 where a predetermined included angle “a” is defined between the filter panel 25 and the casing 21. The number of the positioning device 48 is preferably 2. These two positioning devices 48 are connected between the side frame 27 and the casing 21 at two opposite lateral sides. Preferably, the two positioning devices 48 are respectively arranged on the middle part of each of the two opposite lateral sides of the side frame 27 (filter panel 25).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. An ultraviolet light source, comprising:
a casing accommodating therein at least one UV light-emitting device for emitting an ultraviolet light;
a translucent panel mounted in said casing for allowing the ultraviolet light emitted by said UV light-emitting device to penetrate therethrough;
a filter panel adapted for filtering the ultraviolet light emitted by said UV light-emitting device;
a side frame surrounding said filter panel; and
at least one hinge made of a metal material or a metal alloy and connected between said side frame and said casing for enabling said side frame and said filter panel to be turned about the axis of said hinge relative to said casing.

2. The ultraviolet light source as claimed in claim 1, wherein said side frame is made of a metal material or a metal alloy.

3. The ultraviolet light source as claimed in claim 1, further comprising a bio-sample placed on said translucent panel.

4. The ultraviolet light source as claimed in claim 3, wherein said filter panel is adapted for filtering the ultraviolet light penetrating through said translucent panel and said bio-sample.

5. The ultraviolet light source as claimed in claim 1, further comprising at least one positioning device connected between said side frame and said casing and adapted for holding said side frame in a predetermined angular position relative to said casing where a predetermined included angle is defined between said side frame and said casing.

6. The ultraviolet light source as claimed in claim 1, wherein said filter panel is prepared from polymers.

7. The ultraviolet light source as claimed in claim 1, further comprising a protruding member located on said side frame.

8. The ultraviolet light source as claimed in claim 1, wherein said casing comprises a top panel, a bottom panel and a plurality of peripheral panels, said top panel having an opening; said translucent panel is mounted in the opening of said top panel of said casing; said UV light-emitting device is mounted on a top side of said bottom panel inside said casing.
